(19) United States
(12) Patent Application Publication
(10) Pub. No.: US 2013/0182076 A1
(43) Pub. Date: Jul. 18, 2013

(54) ELECTRONIC APPARATUS AND CONTROL METHOD THEREOF

(71) Applicant: KABUSHIKI KAISHA TOSHIBA, Tokyo (JP)

(72) Inventor: Fumitoshi MIZUTANI, Ome-shi (JP)

(73) Assignee: KABUSHIKI KAISHA TOSHIBA, Tokyo (JP)

(21) Appl. No.: 13/675,927

(22) Filed: Nov. 13, 2012

(30) Foreign Application Priority Data
Jan. 12, 2012 (JP) 2012-004249

(51) Int. Cl. H04N 13/04

(52) U.S. Cl. CPC H04N 13/0402
USPC 348/46

(57) ABSTRACT

According to one embodiment, an apparatus includes an output module configured to output a video signal, a display configured to display a video based on the video signal on a screen, an image capture module configured to capture an image of an observer and to output image data, a recognition module configured to perform facial recognition or of left-eye and right-eye regions from the image data, a presentation module configured to present a left-eye image displayed on the screen to a left eye and to present a right-eye image displayed on the screen to a right eye based on a recognition result of the recognition module, and a controller configured to inhibit the facial recognition by the recognition module when the recognition module fails in the facial recognition.

### CROSS-REFERENCE TO RELATED APPLICATIONS

This application is based upon and claims the benefit of priority from prior Japanese Patent Application No. 2012-004249, filed Jan. 12, 2012, the entire contents of which are incorporated herein by reference.

### FIELD

Embodiments described herein relate generally to an electronic apparatus with a glasses-free 3D display and a control method for the electronic apparatus.

### BACKGROUND

In recent years, various display apparatuses for watching stereoscopic images (three-dimensional images) are provided. One of such display apparatuses is based on a glasses-free stereoscopic scheme (glasses-free three-dimensional scheme). The glasses-free stereoscopic scheme includes, for example, spatial division schemes by which a left-eye image and a right-eye image are simultaneously displayed on a liquid crystal display (LCD), and time-division display schemes by which left-eye images and right-eye images are alternately displayed.

One of the spatial division display scheme is, for example, a scheme (lenticular scheme or parallax barrier scheme) by which a mechanism named a parallax wall for making respectively different light rays enter into left and right eyes controls directions of emitted light corresponding to pixels in the left-eye and right-eye images.

According to the lenticular scheme or parallax scheme, a technology of detecting the position of a face region of an observer and then controlling a direction of emitting light corresponding to each of pixels in an image in accordance with the detected position has been developed in order to allow the observer to properly perceive a stereoscopic image.

In recent years, there is a demand for more reduction of power consumption.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an exterior of an electronic apparatus according to an embodiment.

FIG. 2 is an exemplary block diagram showing a system configuration of the electronic apparatus according to the embodiment.

FIG. 3 is an exemplary block diagram showing an example configuration of a 3D display system employed in the electronic apparatus according to the embodiment.

FIG. 4 is an exemplary diagram for explaining a pixel-array transform processing which is performed by a pixel-array transformer.

FIG. 5 is an exemplary diagram showing refractive index distribution when a face of an observer exists on a substantial center line of a screen.

FIG. 6 is an exemplary diagram showing refractive index distribution when the face of the observer exists on the left side relative to the substantial center line of the screen.

FIG. 7 is an exemplary diagram showing refractive index distribution when the face of the observer exists on the right side relative to the substantial center line of the screen.

FIG. 8 is an exemplary diagram showing a flowchart of processing steps by a recognition controller.

### DETAILED DESCRIPTION

Various embodiments will be described hereinafter with reference to the accompanying drawings.

In general, according to one embodiment, an output module, a display, an image capture module, a recognition module, a presentation module, and a controller. The output module is configured to output a video signal including a left-eye image and a right-eye image of a three-dimensional image. The display is configured to display a video based on the video signal on a screen. The image capture module is configured to capture an image of an observer and to output image data. The recognition module is configured to perform facial recognition of the observer or of left-eye and right-eye regions of the observer from the image data. The presentation module is configured to present the left-eye image displayed on the screen to a left eye of the observer and to present the right-eye image displayed on the screen to a right eye of the observer based on a recognition result of the recognition module. The controller is configured to inhibit the facial recognition by the recognition module when the recognition module fails in the facial recognition.

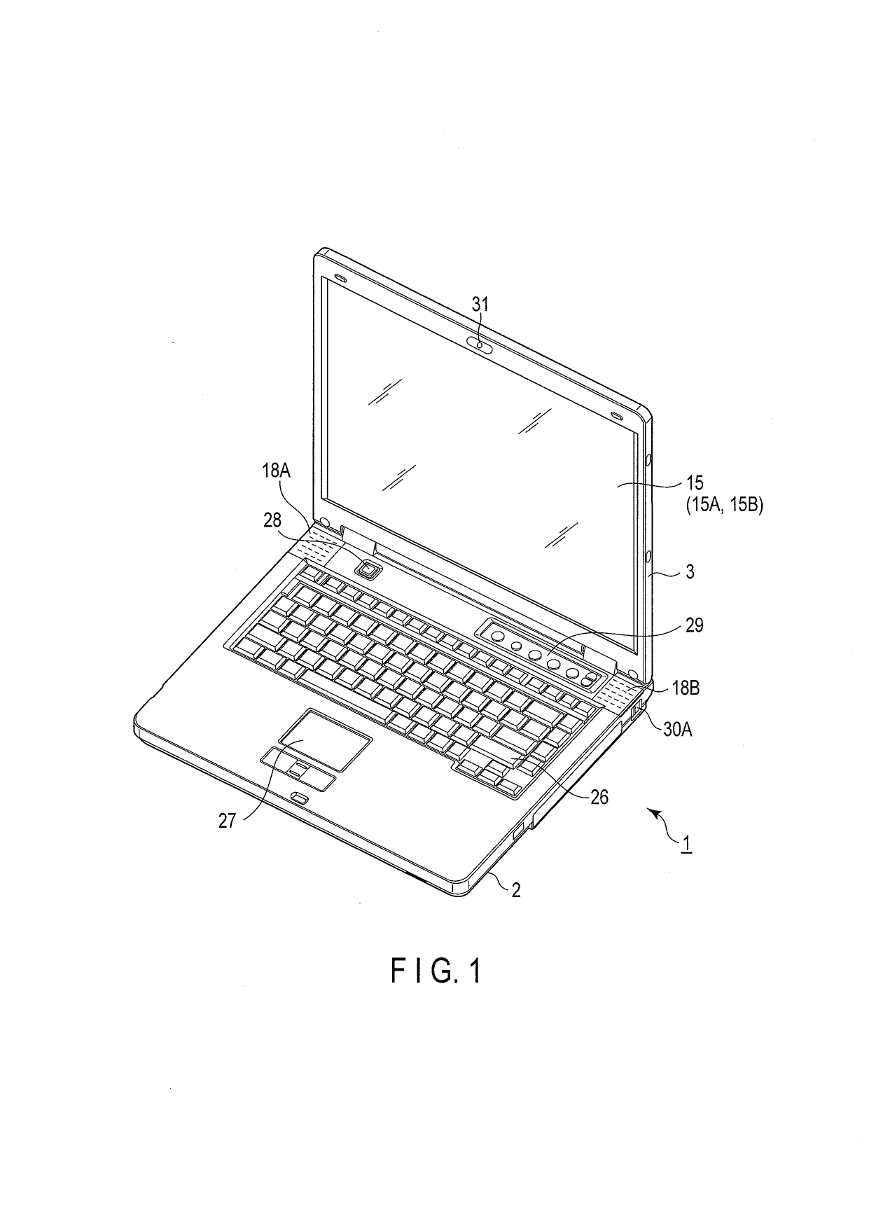

FIG. 1 is a perspective view showing an exterior of an electronic apparatus according to an embodiment. The electronic apparatus is produced as a notebook-type personal computer 1. The information processing apparatus may also be produced as a tablet computer, a PDA, or a smartphone.

As shown in FIG. 1, the present computer 1 comprises a computer body 2 and a display unit 3.

A glasses-free three-dimensional (3D) display 15 and a camera 31 are built into the display unit 3. The glasses-free 3D display 15 performs three-dimensional display according to a glasses-free stereoscopic scheme (lenticular scheme or parallax scheme). The glasses-free 3D display 15 further comprises a liquid crystal display (LCD) 15A and a lens unit 15B provided on the LCD 15A. A user can perceive a three-dimensional image with naked eyes without glasses by seeing the image displayed on the glasses-free 3D display 15.

The camera 31 is provided to be able to pick up the user who sees the image displayed on the glasses-free 3D display 15. The camera 31 outputs frame image data at fifteen frames per second.

The display unit 3 is attached to a computer body 2 in a manner that the display unit 3 can be pivoted between an open position to expose an upper surface of the computer body 2 and a closed position to cover the upper surface. The glasses-free 3D display 15 further comprises a liquid crystal display (LCD) 15A and a lens unit 15B. The lens unit 15B is bonded to the LCD 15A. The lens unit 15B comprises a plurality of lens mechanisms for emitting a plurality of light rays corresponding to a plurality of pixels in predetermined directions, the pixels corresponding to a plurality of pixels included in the image displayed on the LCD 15A. The lens unit 15B is, for example, a liquid-crystal gradient index (GRIN) lens capable of electrically switching functions required for three-dimensional image display. Since the liquid crystal GRIN lens generates a refractive index distribution through electrodes by using a flat liquid crystal layer, the liquid crystal GRIN lens can display a three-dimensional image in a specified region in the screen while displaying a two-dimensional image in another region. That is, a three-dimensional image display region (glasses-free 3D display region) for displaying a three-dimensional image and a two-dimensional image display region for displaying a two-dimensional image can be partially switched inside the screen by changing refractive indices of lenses between the region for displaying three-dimensional image and the region for displaying two-dimensional image.

In the glasses-free 3D region in the screen, for example, a left-eye image and a right-eye image are displayed alternately in units of pixels in the horizontal direction. Further, light corresponding to pixels for the left-eye image and light corresponding to pixels for the right-eye image are refracted by a lens part for the glasses-free 3D region in a manner that the pixels for the left-eye image and the pixels for the right-eye image, which are displayed alternately, reach the left eye and the right eye, respectively. On the other side, in the two-dimensional image display region (2D region), light rays corresponding to the pixels for the two-dimensional image are emitted without being refracted by a lens part corresponding to the 2D region. The position and size of the region to be set as a glasses-free 3D region in the screen can be specified arbitrarily. The remaining region in the screen other than the glasses-free 3D region forms a 2D region.

The computer body 2 has a thin box-type housing. A keyboard 26, a power button 28 to power on/off the computer 1, an input operation panel 29, a pointing device 27, and loudspeakers 18A and 18B are provided on the upper surface of the housing. Various operation buttons are provided on the input operation panel 29. The group of buttons include a group of buttons for controlling TV functions (watching, recording, and playback of recorded broadcast program data/video data).

For example, an antenna terminal 30A for receiving TV broadcast is provided on the right side of the computer body 2. On the back of the computer body 2, for example, there is provided an external display connection terminal in compliance with high-definition multimedia interface (HDMI) standards. The external display connection terminal is used to output image data (motion image data) included in image content data, such as broadcast program data, to an external display.

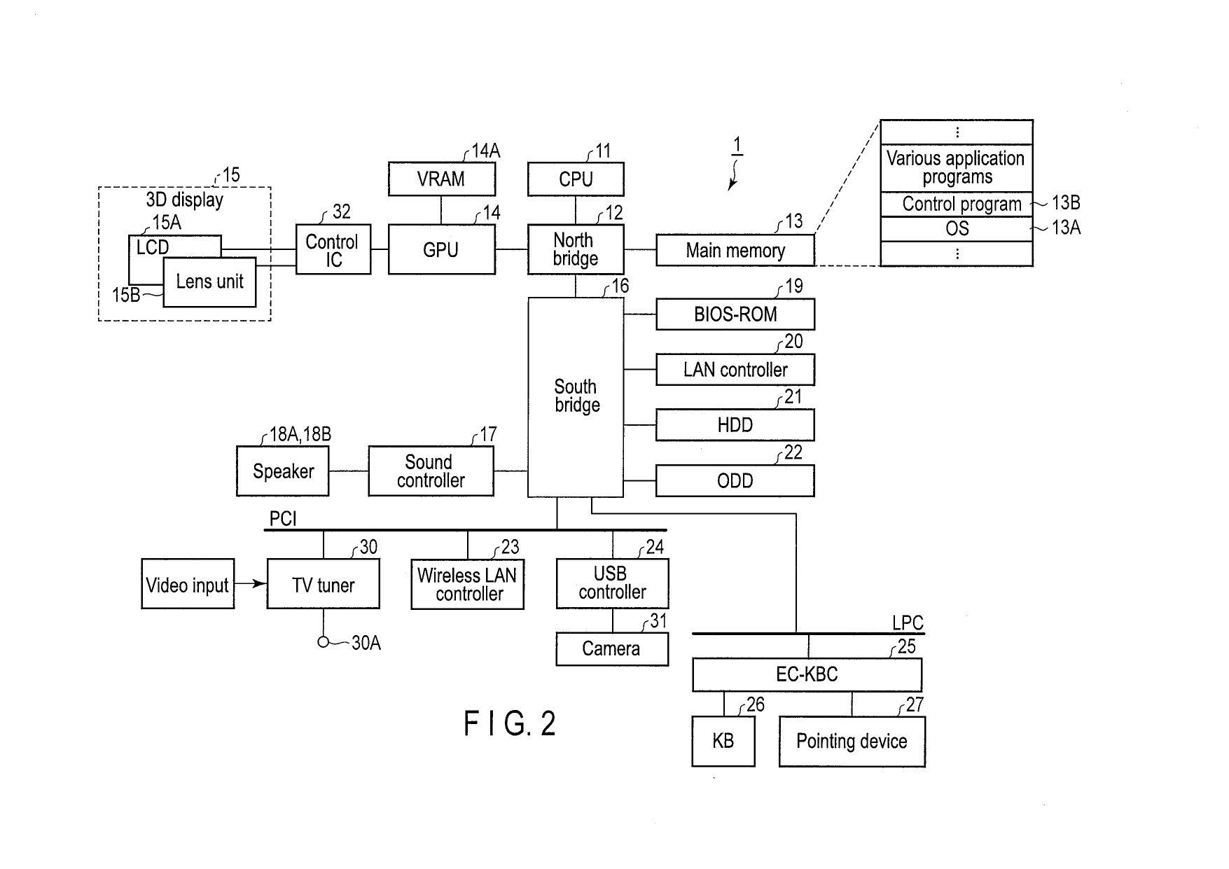

FIG. 2 shows a system configuration of the computer 1.

As shown in FIG. 2, the computer 1 comprises a central processing unit (CPU) 11, a north bridge 12, a main memory 13, a graphics processing unit (GPU) 14, a video memory (VRAM) 14A, the glasses-free 3D display 15, a south bridge 16, a sound controller 17, the loudspeakers 18A and 18B, a BIOS-ROM 19, a LAN controller 20, a hard disc drive (HDD) 21, an optical disc drive (ODD) 22, a wireless LAN controller 23, a USB controller 24, an embedded controller/keyboard controller (EC/KBC) 25, the keyboard (KB) 26, a pointing device 27, a TV tuner 30, a camera 31, and a control IC 32.

The CPU 11 is a processor which controls operation of the computer 1. The CPU 11 executes an operating system (OS) 13A, a control program 13B, and various application programs, which are loaded from the HDD 21 into the main memory 13. The application programs include several application programs which support 3D (hereinafter referred to as 3D application programs). The 3D application programs are, for example, a TV application program, a player application program, and a game application program.

The TV application program is to perform watching/listening and recording of broadcast content, and can deal with broadcast program data in both of 2D and 3D formats. A known 3D format is the side-by-side format or the top-and-bottom format.

The TV application program has a 2D-3D conversion function to convert two-dimensional image data into three-dimensional image data, for each frame of broadcast program data in the 2D format. In the 2D-3D conversion, a depth value is estimated for each of pixels of two-dimensional image data. Based on the estimated depth value of each pixel, a plurality of parallax images such as two parallax images including left-eye and right-eye images are generated.

The player application program is to reproduce video content stored in storage media such as DVDs, and can deal with both 2D and 3D content. The player application program may also have the 2D-3D conversion function as described above.

The control program 13B is to control the 3D application programs each. In common system designing, the number of regions which can be set as glasses-free 3D regions is limited, for example, to one to avoid cost increase. In order to simultaneously display different three-dimensional images respectively in a plurality of regions in a screen, a great number of hardware resources are required and cause costs increase.

Further, the control program 13B has a function to adaptively control display modes (2D and 3D modes) of the 3D application program, depending on use situations of the glasses-free 3D region.

Further, the CPU 11 also executes a basic input/output system (BIOS) stored in the BIOS-ROM 19. The BIOS is a program for hardware control.

The north bridge 12 is a bridge device which connects a local bus and the south bridge 16 to each other. The north bridge 12 also includes a memory controller which performs access control on the main memory 13. Further, the north bridge 12 has a function to communicate with the GPU 14.

The GPU 14 is a device which controls the LCD 15A used as a display of the computer 1. A display signal generated by the GPU 14 is fed to the LCD 15A. The LCD 15A displays images, based on the display signal.

The south bridge 16 controls devices on a Peripheral Component Interconnect (PCI) bus and a Low Pin Count (LPC) bus. The south bridge 16 includes a memory controller which performs access control on the BIOS-ROM 19 and an Integrated Drive Electronics (IDE) controller for controlling the HDD 21 and the ODD 22. The south bridge 16 further has a function to communicate with the sound controller 17 and LAN controller 20.

The sound controller 17 is a sound generator device and outputs audio data as a target to reproduce, to the loudspeakers 18A and 18B. The LAN controller 20 is a wired communication device which performs wired communication, for example, according to the Ethernet (registered trademark) standards. The wireless LAN controller 23 is a wireless communication device which performs wireless communication, for example, according to the IEEE 802.11 standards. The USB controller 24 communicates with external devices, for example, through a cable according to the USB 2.0 standards.

The EC/KBC 25 is a single-chip microcomputer which integrates an embedded controller for performing power management, the keyboard (KB) 26, and a keyboard controller for controlling the pointing device 27. The EC/KBC 25 has a function to power on/off the computer 1 in accordance with operation by the user.

The TV tuner 30 is a receiver which receives broadcast program data which is broadcast by television (TV) broadcast signals, and is connected to an antenna terminal 30A. The TV tuner 30 is realized, for example, as a digital TV tuner which can receive digital-broadcast program data such as terrestrial digital TV broadcast. The TV tuner 30 receives and demodulates a broadcast signal, and outputs audio data and motion image data which includes left-eye and right-eye images. The TV tuner 30 also has a function to capture video data which is input from external devices.

The control IC 32 transforms arrays of pixels to be displayed in the glasses-free 3D region in a manner that parallax images are arranged alternately in units of pixels in the horizontal direction. When a 3D image is displayed by using two parallax images including left-eye and right-eye images, arrays of pixels to be displayed in a glasses-free 3D region are transformed in a manner that the left-eye and right-eye images are displayed, alternately arrayed in units of pixels in the horizontal direction on the 3D region.

Further, in accordance with a request from the control program 13B, the control IC 32 controls a part of the lens unit 15B corresponding to the glasses-free 3D region in a manner that the part of the lens unit 15B has predetermined refractive index distribution for 3D display. In this manner, a lens effect appears in this part of the lens unit 15B. Therefore, on the glasses-free 3D region, emitting directions of light rays corresponding respectively to the pixels of the left-eye image and emitting directions of light corresponding respectively to the pixels of the right-eye are controlled in a manner that the pixels of the left-eye image and the pixels of the right-eye image respectively reach the left and right eyes. In this case, there is a possibility that observation positions where the left-eye and right-eye images can be properly observed by the left and right eyes are restricted to limited positions.

Therefore, the apparatus 1 uses face tracking upon necessity. According to the face tracking, light emitting directions corresponding to the pixels of the right eye and those of the left eyes are adaptively controlled, depending on the observation position of an observer (e.g., the position of the face region or positions of the left-eye region and right-eye region of the observer). In this manner, a view field where three-dimensional images are perceivable can be widened.

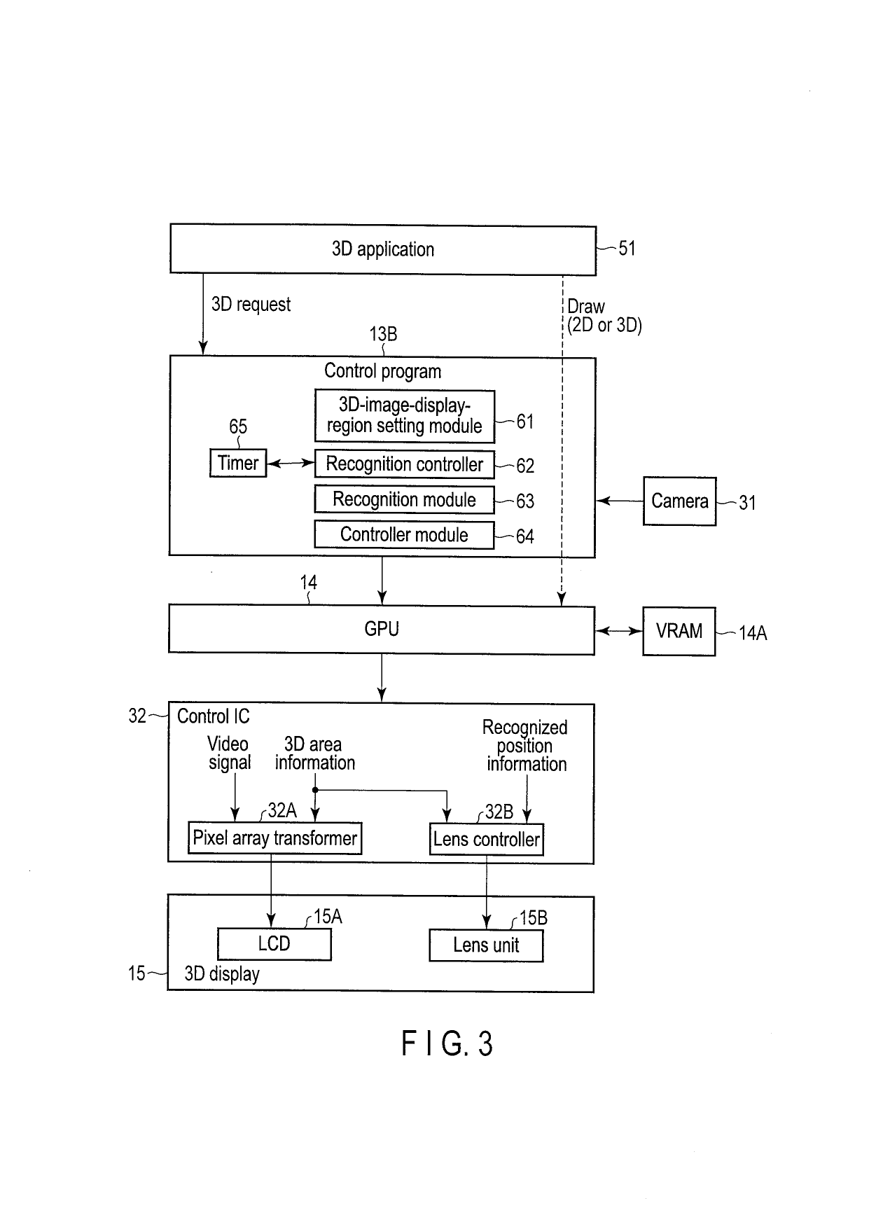

Next, referring to FIG. 3, descriptions will be made of an example configuration of a 3D display system employed in the present embodiment.

A 3D-support application program 51 is exemplified as one of a plurality of 3D-support application programs which are executed by the computer 1 according to the embodiment.

The 3D-support application program 51 has a function to present the user a content handled by the 3D-support application program 51, in one of 3D and 2D modes. While the 3D-support application program 51 is in the 3D mode, the 3D-support application program 51 draws, on the VRAM 14A, a plurality of parallax images (for example, two parallax images including left and right eyes) corresponding to the content handled by the 3D-support application program 51. In this case, the 3D-support application program 51 may draw the left and right eye images on the VRAM by the side-by-side format. While the 3D-support application program 51 is in the 2D mode, the 3D-support application program 51 draws, on the VRAM 14A, a two-dimensional image corresponding to the content handled by the 3D-support application program 51.

When the 3D-support application program 51 is started up or when a 3D button on the screen of the 3D-support application program 51 is pressed, the 3D-support application program 51 sends a request (3D request) for displaying a three-dimensional image, to the control program 13B. When the 3D request is permitted by the control program 13B, the 3D-support application program 51 can operate in the 3D mode.

The control program 13B comprises a three-dimensional-image-display-region setting module 61, a recognition controller 62, a recognition module 63, and a controller 64. The 3D-image-display-region setting module 61 performs a processing to display three-dimensional image based on a plurality of parallax images which are drawn by a 3D application program.

Here is supposed that the control program 13B receives a 3D request from the 3D-support application program 51 in a state that no glasses-free 3D region is set in the screen of the glasses-free 3D display 15.

The 3D-image-display-region setting module 61 sets a first region in the screen, as a glasses-free 3D region, in a manner that a three-dimensional image based on a plurality of parallax images corresponding to a content handled by the first 3D application program 51 is displayed in the first region in the screen corresponding to the window of the 3D application program 51. In this case, the 3D-image-display-region setting module 61 may transmit coordinate information which specifies the first region, to the control IC 32 in order to set the first region in the screen as a glasses-free 3D region.

The recognition controller 62 receives video data including a plurality of frame image data imaged by the camera 31. The recognition controller 62 feeds the received frame image data to the recognition module 63 which will be described later. Also, the recognition controller 62 determines whether to feed a recognition result or not, depending on a recognition result about a face region which has been made by the recognition module 63 with use of previous frame image data. If recognition of a face region by using a previous frame image has succeeded, the recognition controller 62 feeds the recognition result about the previous frame image data. If recognition of a face region using previous frame image data has failed, the recognition controller 62 feeds the recognition result about the frame image data of the previous frame to the recognition module 63.

The recognition module 63 recognizes a position of a face region of an observer or positions of left and right eyes of the observer from each of frame image data of the video data imaged by the camera 31. When only frame image data is fed from the recognition controller 62, the recognition module 63 tries recognition of a face region (or left-eye and right-eye regions) in a first recognition mode. In the first recognition mode, the face region (or positions of left-eye and right-eye regions) is recognized from entire frame image data. Otherwise, when frame image data and previous image data are fed from the recognition controller 62, the recognition module 63 tries recognition of a face region (or positions left-eye and right-eye regions) in a second recognition mode. In the second recognition mode, a face region (or positions of left-eye and right-eye regions) is recognized from a partial region in the frame image data including a region corresponding to the recognition result about the previous frame image data. When recognition of a face region succeeds, the recognition module 63 informs the recognition controller 62 of the success and a recognition result thereof. Otherwise, when recognition of a face region fails, the recognition module 63 informs the recognition controller 62 of the failure.

When the recognition controller 62 is informed of the success and recognition result thereof, the recognition controller 62 informs the control IC 32 of the recognition result (recognized position information).

When the recognition controller 62 is informed of the failure, the recognition controller 62 informs the control IC 32 of a last recognition result (recognized position information). The recognition controller 62 further receives a value of a timer 65. If the value of the timer 65 is zero, the controller starts the timer 65. Otherwise, if the value of the timer 65 is not zero, the controller determines whether the value of the timer 65 exceeds a setting value or not. If the value of the timer 65 exceeds, the recognition controller 62 stops transmitting frame image data to the recognition module 63, to stop recognition processing by the recognition module 63. The recognition controller 62 instructs the controller 64 to stop three-dimensional-image display processing.

The GPU 14 generates a video signal which forms a screen image, based on image data drawn on the VRAM 14A. The control IC 32 comprises a pixel array transformer 32A and a lens controller 32B. The pixel array transformer 32A receives the video signal from the GPU 14 and also receives 3D area information from the control program 13B. The 3D area information is coordinate information which indicates a region (for example, a rectangular region) in the screen, which is to be set as a glasses-free 3D region. The 3D area information may include four coordinate information items which respectively indicate four vertices of the rectangular region.

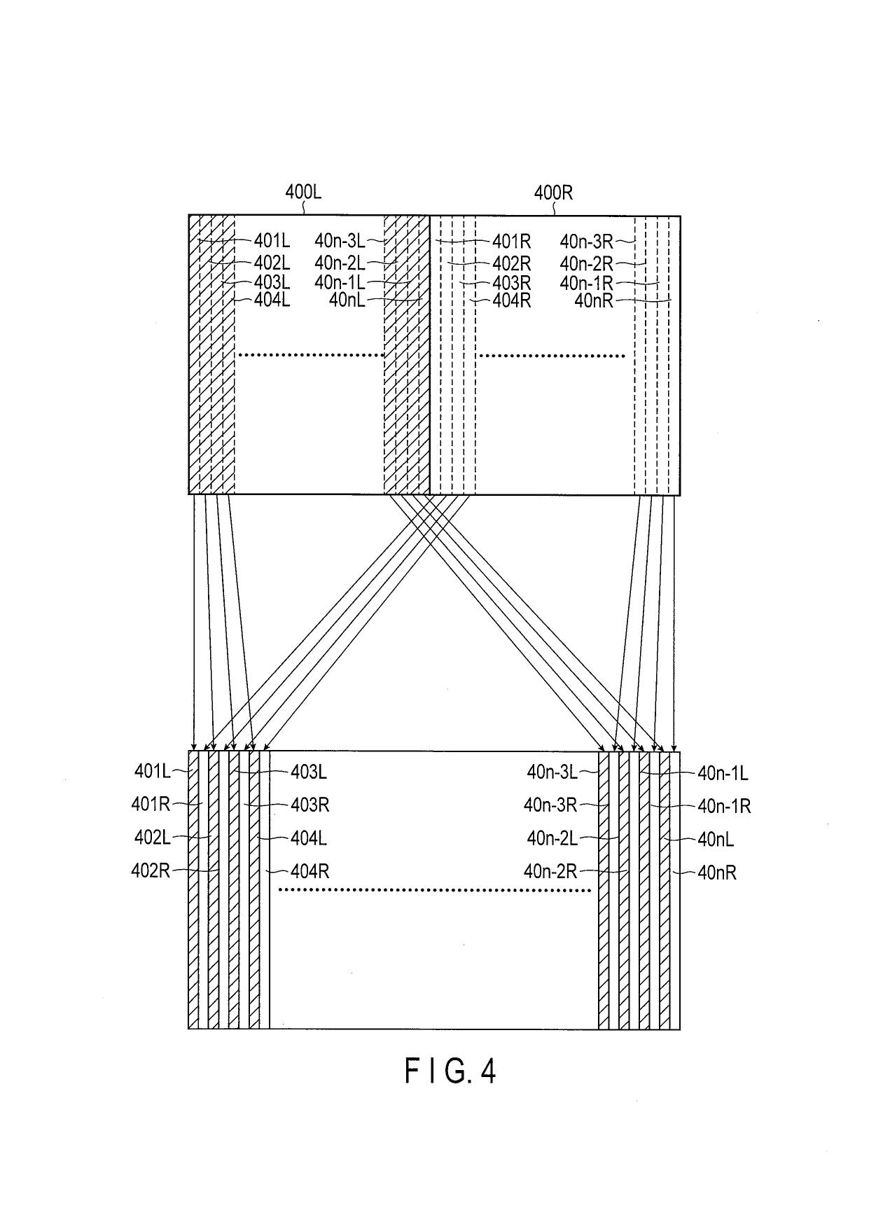

Based on the 3D area information, the pixel array transformer 32A extracts an image part corresponding to the glasses-free 3D region from an image of an entire screen corresponding to the received video signal. Further, the pixel array transformer 32A performs a pixel-array transform processing on the extracted image part. Through the pixel-array transform processing, a plurality of parallax images included in the extracted image part are rearranged to be alternately arrayed in units of pixels in the horizontal direction. For example, when two parallax images including left-eye and right-eye images are used, the left-eye and right-eye images are rearranged in a manner that the left-eye image and the right-eye image are arrayed alternately in units of pixels in the horizontal direction. For example, according to the side-by-side format including a left-eye image 400L and a right-eye image 400R, as shown in FIG. 4, pixels are arranged in an order of a first column image region 401L of the left-eye image 400L, a first column image region 401R of the right-eye image 400R, a second column image region 402L of the left-eye image 400L, a second column image region 402R of the right-eye image 400R, a third column image region 403L of the left-eye image 400L, a third column image region 403R of the right-eye image 400R, a fourth column image region 404L of the left-eye image 400L, a fourth column image region 404R of the right-eye image 400R, . . . , n-3th column pixel region 40n-3L of the left-eye image 400L, n-3th column pixel region 40n-3R of the right-eye image 400R, n-2th column pixel region 40n-2L of the left-eye image 400L, n-2th column pixel region 40n-2R of the right-eye image 400R, n-1th column pixel region 40n-1L of the left-eye image 400L, n-1th column pixel region 40n-1R of the right-eye image 400R, nth column pixel region 40nL of the left-eye image 400L, nth column pixel region 40nR of the right-eye image 400R. In this manner, in the glasses-free 3D region corresponding to the glasses-free 3D region on the screen of the LCD 15A, the left-eye and right-eye images are displayed alternately in units of pixels in the horizontal direction. The other remaining image part than the image part corresponding to the glasses-free 3D region is displayed on the LCD 15A without being subjected to the pixel array transform processing.

Based on the 3D area information and face region (or positions of the left-eye and right-eye regions), the lens controller 32B controls the lens unit 15B in a manner that a part in the lens unit 15B corresponding to the glasses-free 3D region has predetermined refractive index distribution. More specifically, control is performed so as to allow the left-eye image in the glasses-free 3D region to be seen only from the left eye of the observer as well as the right-eye image only from the right-eye.

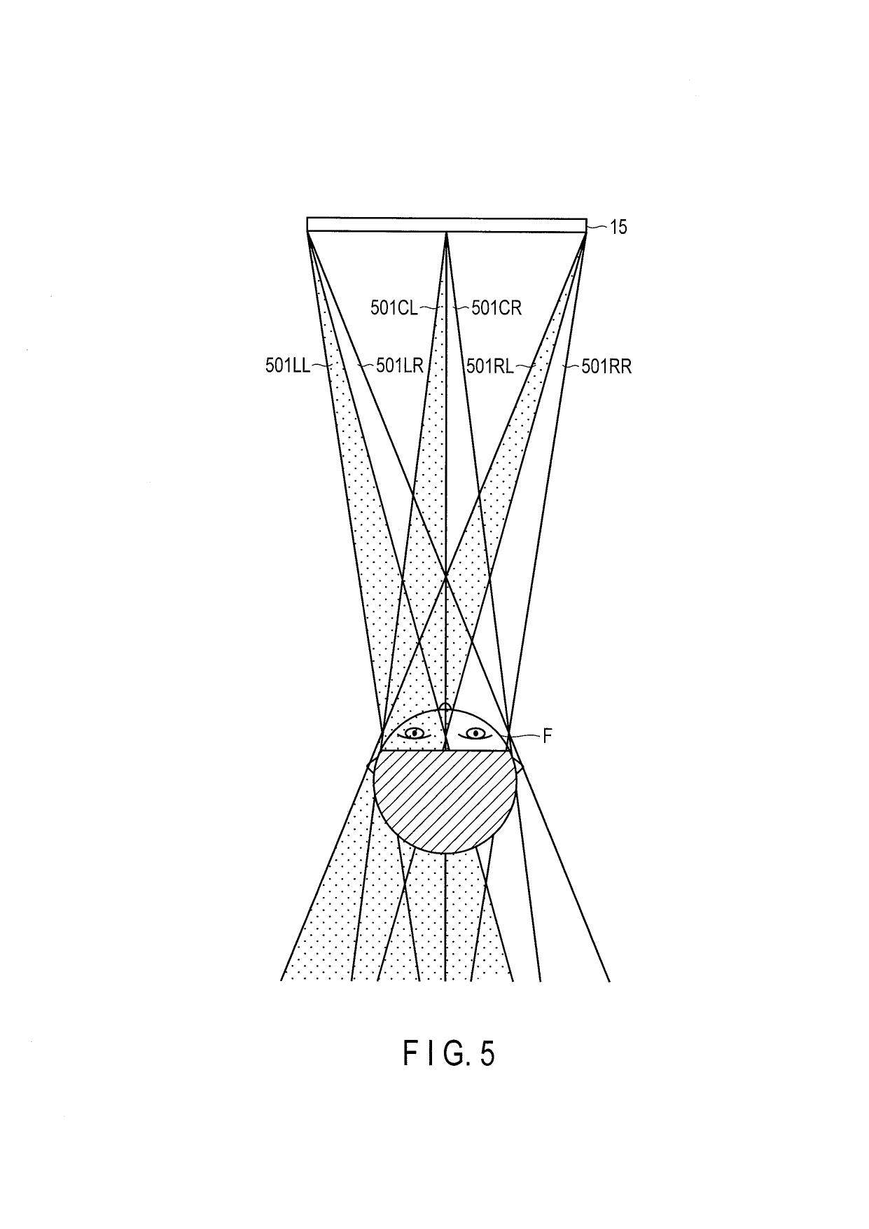

An example of the refractive index distribution will be described with reference to FIGS. 5, 6, and 7. FIGS. 5, 6, and 7 show cases in which the entire glasses-free 3D display 15 is set as a glasses-free 3D region.

For example, when a face F of an observer exists at the substantial center of the glasses-free 3D display 15, the lens unit 15B is controlled so as to make left-eye images 501LL, 501CL, and 501RL into the left eye of the observer as well as right-eye images 501LR, 501CR, and 501RR into the right eye, as shown in FIG. 5.

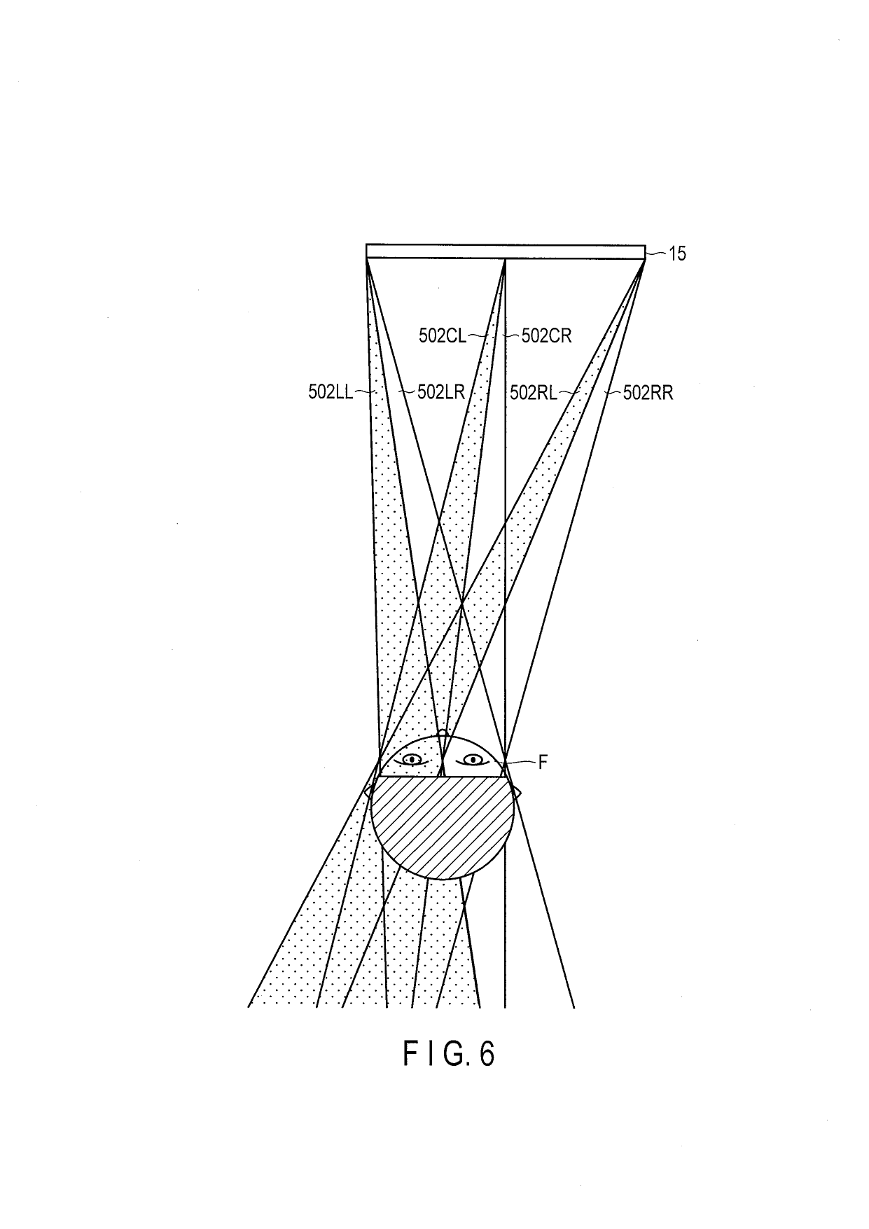

When the face F of the observer exists on the left side relative to the substantial center of the glasses-free 3D display 15, the lens unit 15B is controlled so as to make left-eye images 502LL, 502CL, and 502RL into the left eye of the observer as well as right-eye images 502LR, 502CR, and 502RR into the right eye, as shown in FIG. 6.

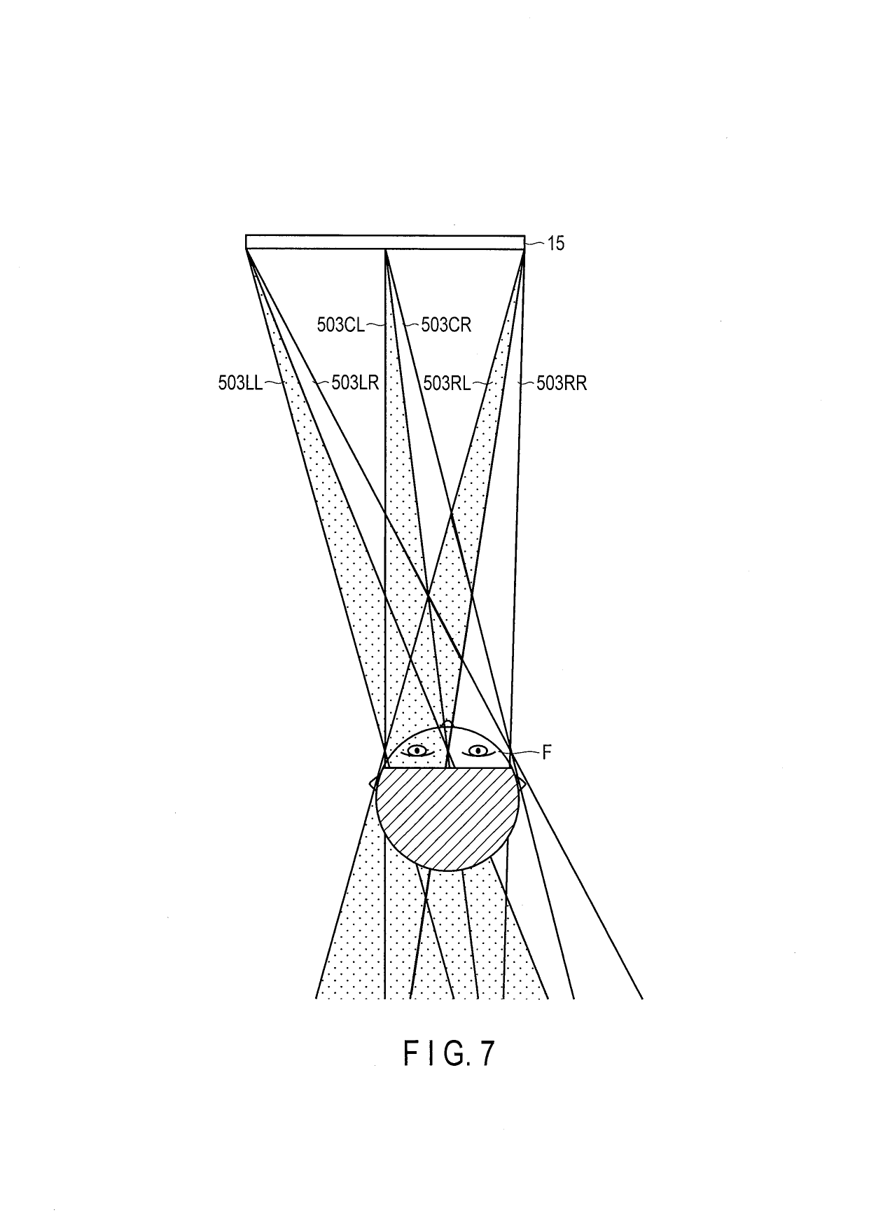

When the face F of the observer exists on the right side relative to the substantial center of the glasses-free 3D display 15, the lens unit 15B is controlled so as to make left-eye images 503LL, 503CL, and 503RL into the left eye of the observer as well as right-eye images 503LR, 503CR, and 503RR into the right eye, as shown in FIG. 7.

In the first recognition mode of recognizing a position of a face region from entire frame image data, load to the CPU 11 becomes approximately twice greater than load to the CPU 11 in the second recognition mode of recognizing the position of the face region from a partial region of the frame image data. When the face region is continuously undetected for a constant time period, the present apparatus then stops the recognition processing for the face region by the recognition module 63 to save electric power. The present apparatus further stops the three-dimensional-image display processing to save more electric power.

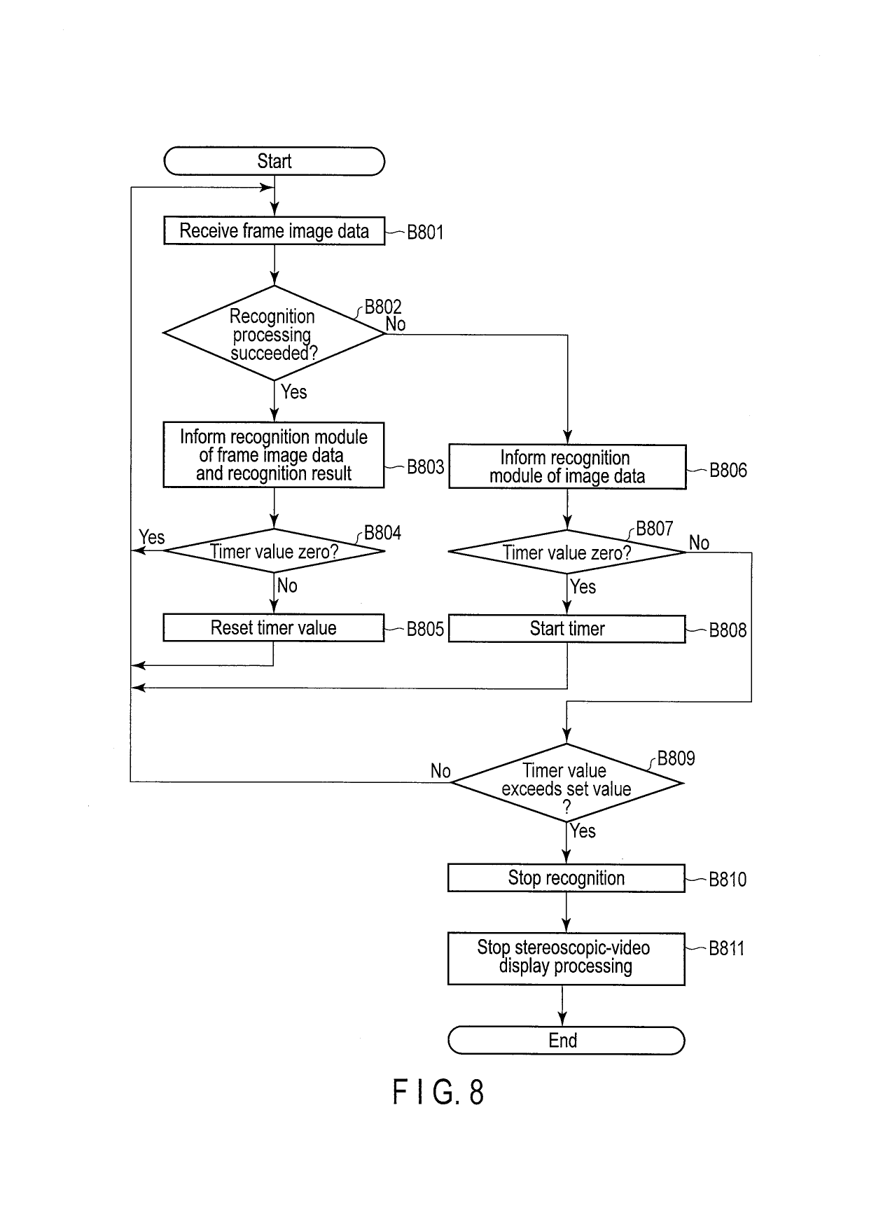

Referring to a flowchart in FIG. 8, the control processing for the face recognition processing by the recognition controller 62 will be described.

The recognition controller 62 receives frame image data transmitted from the camera 31 (block B801). The recognition controller 62 determines whether recognition processing using previous frame image data which had been received prior to the frame image data received in the block B801 succeeded or not (block B802). If the previous recognition processing succeeded (block B802, Yes), the recognition controller 62 transfers recognition results about the frame image data received in the block B801 and about the previous frame image data, to the recognition module 63 (block B803). The recognition controller 62 determines whether a value of the timer is zero or not (block B804). If the value of the timer is not determined to be zero (No in block B801), the recognition controller 62 resets the timer to set zero as the value of the timer (block B805).

In block B802, if the recognition result is not determined to have succeeded (block B802, No), the frame image data received in block B801 is transferred to the recognition module 63 (block B806). The recognition controller 62 determines whether the value of the timer is zero or not (block B807). If the value of the timer is determined to be zero (block B807, Yes), the recognition controller 62 causes the timer to run (block B808). If the value of the timer is determined to be zero (block B807, No), the recognition controller 62 determines whether the value of the timer exceeds a set value or not (block B809). If the value is determined to exceed the set value (block B809, Yes), operation of the camera 31 is stopped and the recognition processing is also stopped (block B810). The recognition controller 62 instructs the controller 64 to stop (or inhibit) the three-dimensional-image display processing (block B811). The controller 64 stops the three-dimensional-display processing.

In order to restart display of the three-dimensional image, the user needs only to operate a 3D button on the screen of the 3D-support application program 51. To inform the user of ability to restart three-dimensional image display by operating the 3D button, a popup may be presented to the user indicating that three-dimensional image display can be restarted only if the user operates the 3D button.

When background images change, i.e., when there is a great difference between sequential frame images, the three-dimensional-image display processing may be continued even if the face region of the observer cannot be recognized. When there is a great difference between sequential frame images, the apparatus 1 may be considered to be demonstrated in a shop, and the three-dimensional-image display processing is therefore not stopped.

According to the control processing for recognition processing, the recognition processing is inhibited when recognition fails. Accordingly, power saving more improves.

Processing steps of the control processing for recognition processing according to the present embodiment can be performed entirely by software. Therefore, the same effects as obtained in the above embodiment can be easily achieved by simply installing and executing a program in a computer with a glasses-free 3D region capable of displaying a three-dimensional image in a three-dimensional-image display region, from a computer-readable storage medium storing the program which executes the processing steps of the control processing.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
an output module configured to output a video signal including a left-eye image and a right-eye image of a three-dimensional image;
a display configured to display a video based on the video signal on a screen;
an image capture module configured to capture an image of an observer and to output image data;
a recognition module configured to perform facial recognition of the observer or of left-eye and right-eye regions of the observer from the image data;
a presentation module configured to present the left-eye image displayed on the screen to a left eye of the observer and to present the right-eye image displayed on the screen to a right eye of the observer based on a recognition result of the recognition module; and
a controller configured to inhibit the facial recognition by the recognition module when the recognition module fails in the facial recognition.

2. The electronic apparatus of claim 1, wherein
the facial recognition is performed based on the recognition result for a previous frame image included in the image data when the recognition module is set to a first recognition mode of the facial recognition, the previous frame image is previous to a first frame image, the recognition module is set to a second recognition mode of the facial recognition when the recognition module in the first recognition mode fails the facial recognition, and the facial recognition is performed by using the entire first frame image when the facial recognition is set to the second recognition mode of the facial recognition, and
the controller is configured to inhibit the facial recognition by the recognition module when the recognition module fails in the facial recognition using the first frame image in the second recognition mode.

3. The apparatus of claim 1, wherein the controller is configured to inhibit the facial recognition by the recognition module when a duration for which the recognition module continuously fails in the facial recognition is longer than a first time period.

4. The apparatus of claim 1, wherein the output module comprises a tuner configured to receive a broadcast signal and to demodulate the received broadcast signal, in order to output audio data and motion image data comprising the left-eye image and the right-eye image.

5. The apparatus of claim 1, wherein the output module comprises a generator configured to estimate a depth position for each pixel in an image frame of video data by analyzing the image frame, and to generate the left-eye image and the right-eye image corresponding to the image frame based on the depth position estimated for each pixel.

6. The apparatus of claim 1, wherein the output module comprises an optical disc reproduction module configured to output audio data and motion image data including the left-eye image and right-eye image, in order to reproduce data recorded in an optical disc.

7. A control method for an electronic apparatus comprising an output module configured to output a video signal comprising a left-eye image and a right-eye image of a three-dimensional image, a display configured to display a video based on the video signal, on a screen, an image capture module configured to capture an image of an observer and to output image data; a recognition module configured to perform facial recognition of the observer or of left-eye and right-eye regions of the observer from the image data; and a presentation module configured to present the left-eye image displayed on the screen to a left eye of the observer and to present the right-eye image displayed on the screen to a right eye of the observer, the method comprising;
inhibiting the facial recognition by the recognition module when the recognition module fails in the facial recognition.

8. A computer-readable non-transitory storage medium having stored thereon a computer program which is executable by a computer, the computer comprising: an output module configured to output a video signal comprising a left-eye image and a right-eye image of a three-dimensional image; a display configured to display a video based on the video signal on a screen; an image capture module configured to capture an image of an observer who observes the video displayed on the screen and to output image data; a recognition module configured to perform facial recognition of the observer or of left-eye and right-eye regions of the observer from the image data; and a presentation module configured to present the left-eye image displayed on the screen to a left eye of the observer and to present the right-eye image displayed on the screen to a right eye of the observer, the computer program controlling the computer to execute functions of:
inhibiting the facial recognition by the recognition module when the recognition module fails in the facial recognition.
